(19) United States
(12) Patent Application Publication
(10) Pub. No.: US 2012/0102267 A1
(43) Pub. Date: Apr. 26, 2012

(54) IMPLEMENTING ENHANCED DATA STORAGE ON REMOVABLE MEDIA TO OPTIMIZE PERFORMANCE AND RELIBILITY

(75) Inventor: Thomas A. Bjork, Rochester, MN (US)

(73) Assignee: INTERNATIONAL BUSINESS MACHINES CORPORATION, Armonk, NY (US)

(21) Appl. No.: 12/908,089

(22) Filed: Oct. 20, 2010

(51) Int. Cl. G06F 12/00

(52) U.S. Cl. 711/111; 711/E12.001

(57) ABSTRACT

A method, system, and computer program product are provided for implementing enhanced data storage in a removable media library to optimize performance and reliability. When two volumes are initially formatted, user specified affinity information is used to identify an affinity between a first volume and a second volume for storing data. A user specified affinity type value is defined by the user specified affinity information. The first volume to be formatted is selected from a first removable media library (RML) and formatted. The second volume to be formatted is selected based upon an identified user specified affinity type value.

### FIELD OF THE INVENTION

The present invention relates generally to the data processing field, and more particularly, relates to a method, system, and computer program product for implementing enhanced data storage in a removable media library to optimize performance and reliability.

### DESCRIPTION OF THE RELATED ART

An automated storage library or removable media library typically includes a plurality of storage bins or slots for retaining data storage media, such as magnetic tapes, magnetic disks, or optical disks, and includes a robotic picker mechanism for picking or gripping a cartridge containing the data storage medium and moving the cartridge between a storage position and an input output device or drive.

A media library device, such as an optical device, contains storage slots, drives, and a robotic arm that moves the two-sided media cartridges from the storage slots to the drives to be read and written. Each side of a cartridge is referred to as a volume. Each volume is stored on a single side of a two-sided cartridge. For example, volumes 1 and 2 reside on cartridge 1; volumes 3 and 4 reside on cartridge 2, and the like.

For many library devices, the drives can only read/write one side of the cartridge; therefore the robotic arm must flip the cartridge to read/write the other side. The process of moving a cartridge from a slot to a drive or flipping the cartridges already in a drive can take anywhere from 5-20 seconds depending on the model of library device.

Since a media library device provides random access to file data, performance inefficiencies can occur when the application/user is attempting to read or write data to both volumes on the same cartridge simultaneously. This could result in very slow response time as the media is continually flipped and flipped again to satisfy the requests. In some implementations movement of the media into the disk drives for reading or writing is managed so that users are unaware that it is not physically possible to read and write all media at the same time.

In some cases it may not be a coincidence that the user is accessing files on both volumes of the same cartridge. For example, the user application might unknowingly minor data to a second volume that happens to be on the other side. Often it is transparent to the user as to which physical cartridge the volumes are on.

A need exists for an efficient and effective mechanism for implementing improved data storage in a removable media library to optimize performance and reliability.

### SUMMARY OF THE INVENTION

A principal aspect of the present invention is to provide a method, system and computer program product for implementing enhanced data storage in a removable media library to optimize performance and reliability. Other important aspects of the present invention are to provide such method, system, and computer program product substantially without negative effects and that overcome many of the disadvantages of prior art arrangements.

In brief, a method, system, and computer program product are provided for implementing enhanced data storage in a removable media library to optimize performance and reliability. When two volumes are initially formatted, user specified affinity information is used to identify an affinity between a first volume and a second volume for storing data. A user specified affinity type value is defined by the user specified affinity information. The first volume to be formatted is selected from a first removable media library (RML) and formatted. The second volume to be formatted is selected based upon an identified user specified affinity type value.

In accordance with features of the invention, the selected first volume and second volume enable enhanced data storage provided by the identified user specified affinity type value being selectively defined in a number of ways by the user.

In accordance with features of the invention, the user specified affinity information is used to intelligently select a plurality of unformatted cartridges and their location either in a single removable media library (RML) or in the location of the storage of a group of removable media libraries (RMLs).

In accordance with features of the invention, when the identified user specified affinity type value is a first affinity type, the second volume to be formatted is selected from a second removable media library (RML) than the first RML of the first volume. The second RML for the selected second volume is at a different physical location than the first RML, such as in a different building or a different city.

In accordance with features of the invention, when the identified user specified affinity type value is another affinity type, such as a second affinity type, the second volume to be formatted is selected from a second removable media library (RML) different than the first RML of the first volume. The second RML for the selected second volume is at the same physical location as the first RML.

In accordance with features of the invention, when the identified user specified affinity type value is another affinity type, such as a third affinity type, the second volume to be formatted is selected from a different cartridge in the same first RML.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1 and 2 are block diagram representations illustrating an example computer system and operating system for implementing enhanced data storage in a removable media library to optimize performance and reliability in accordance with the preferred embodiment;

FIGS. 3 and 4 are flow charts illustrating exemplary sequential steps for implementing enhanced data storage in a removable media library to optimize performance and reliability in accordance with the preferred embodiment; and

FIG. 5 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method, system, and computer program product for implementing enhanced data storage in a removable media library to optimize performance and reliability.

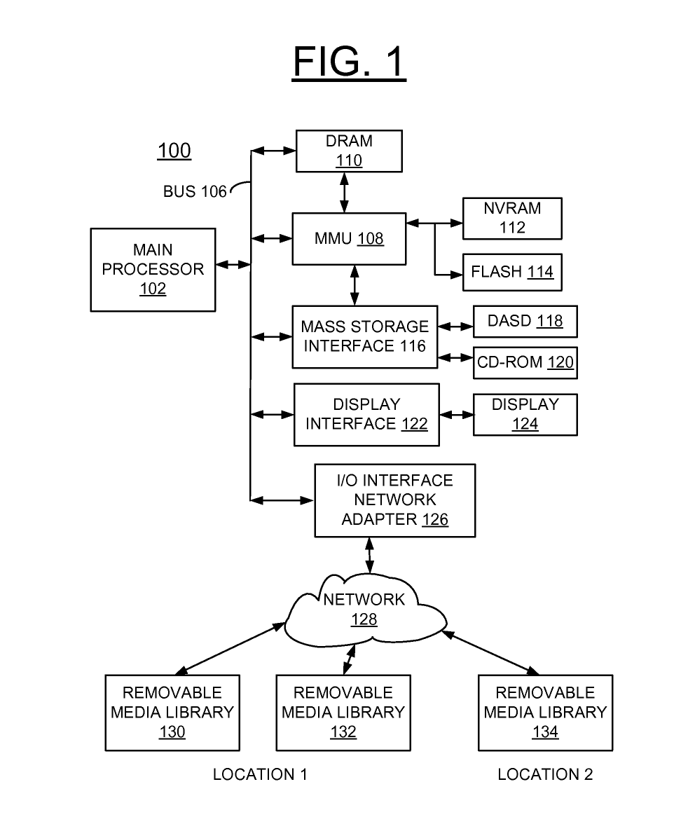

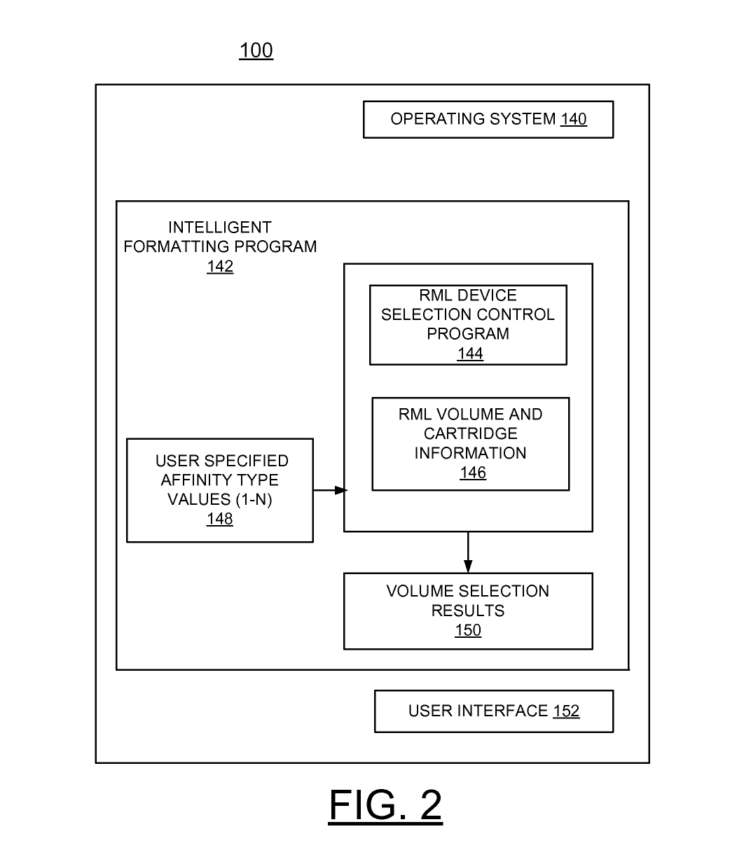

Referring now to the drawings, in FIGS. 1 and 2 there is shown a server computer system generally designated by the reference character 100 for implementing enhanced data storage in a removable media library to optimize performance and reliability in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 coupled to the system bus 106 and connected to a display 124. Computer system 100 includes an input/output (I/O) network adapter 126 coupled to the system bus 106 and connected to a network 128. Computer system 100 includes a plurality of removable media libraries (RMLs) 130, 132, 134 that are connected to the network 128. As shown, the RMLs 130, 132 are provided at a first location and the RLM 134 at a second location.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors.

As shown in FIG. 2, computer system 100 includes an operating system 140, and an intelligent formatting program 142 of the preferred embodiment, an RML device selection control tool or program 144 of the preferred embodiment, and RML volume and cartridge information 146. Computer system 100 includes user specified affinity type values 1—N, 148 of the preferred embodiment, volume selection results 150 of the preferred embodiment, and a user interface 152.

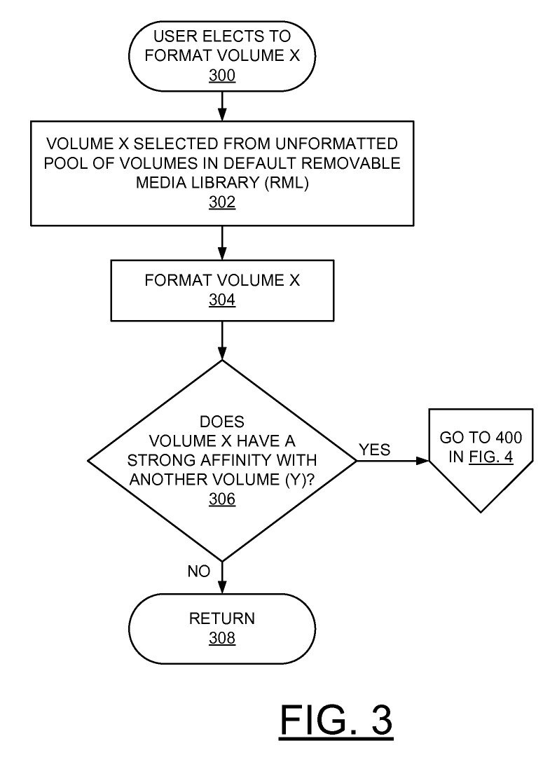

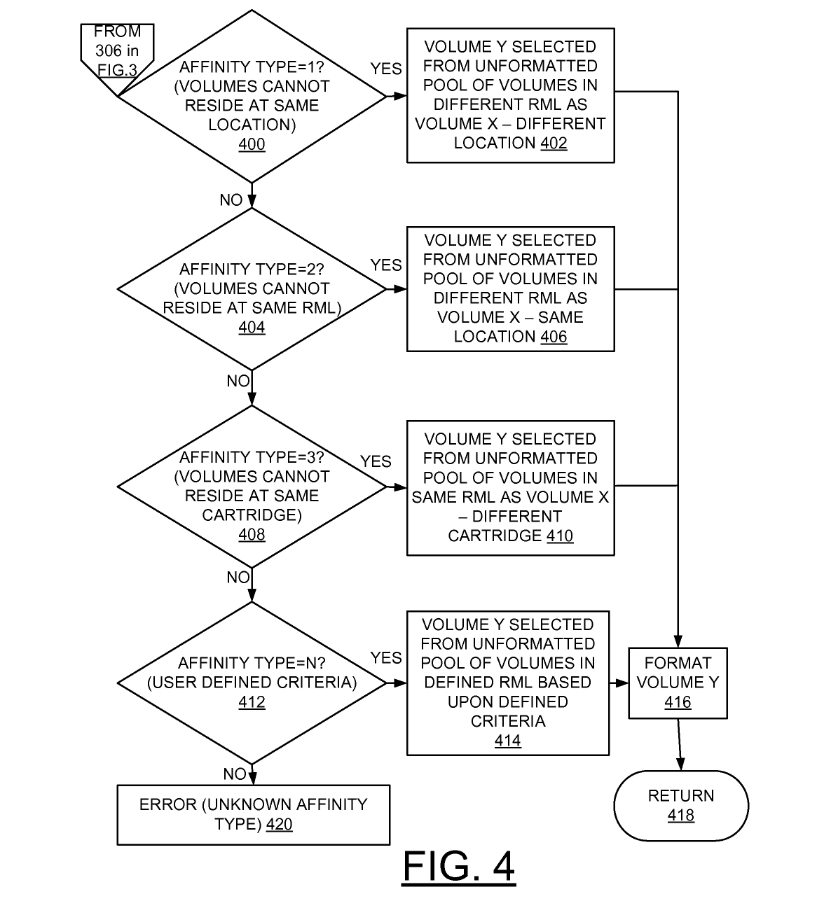

Various commercially available servers and commercially available computers can be used for computer system 100. CPU 102 is suitably programmed by the intelligent formatting program 142 and RML device selection control program 144 to execute the flowcharts of FIGS. 3 and 4 for implementing enhanced data storage in a removable media library to optimize performance and reliability in accordance with the preferred embodiment.

FIGS. 3 and 4 are flow charts illustrating exemplary sequential steps for implementing enhanced data storage in a removable media library to optimize performance and reliability in accordance with the preferred embodiment.

Referring now to FIG. 3, there are shown exemplary sequential steps starting as indicated at a block 300 when a user elects to format a first volume X. As indicated at a block 302, the first volume X is selected from an unformatted pool of volumes in a first removable media library (RML). The selected first volume X is formatted as indicated at a block 304. Checking if the selected first volume X has a strong affinity with another volume (Y) is performed as indicated at a decision block 306. If a strong affinity with another volume is not identified at decision block 306, then the sequential steps return as indicated at a block 308. When a strong affinity with another volume is identified at decision block 306, then the sequential steps continue at a decision block 400 in FIG. 4 with a second volume to be formatted being selected based upon an identified user specified affinity type value, such as, from the stored user specified affinity type values 1−N, 148 in FIG. 2.

Referring also to FIG. 4, as indicated at decision block 400, checking is performed for a user specified affinity type equal to one, which indicates for example, that the two volumes X and Y cannot reside at the same location. If the user specified affinity type equal to one is identified, then the second volume Y is selected from an unformatted pool of volumes in a different, second removable media library (RML) at a different location from the first removable media library (RML) as indicated at a block 402.

Otherwise if the user specified affinity type is not equal to one, checking is performed for a user specified affinity type equal to two, which indicates for example, that the two volumes X and Y cannot reside at the same removable media library (RML) as indicated at a decision block 404. If the user specified affinity type equal to two is identified, then the second volume Y is selected from an unformatted pool of volumes in a different, second removable media library (RML) at the same location as the first removable media library (RML) as indicated at a block 406.

Otherwise if the user specified affinity type is not equal to two, as indicated at a decision block 408 checking is performed for a user specified affinity type equal to three, which indicates for example, that the two volumes X and Y cannot reside at the same cartridge. If the user specified affinity type equal to three is identified, then the second volume Y is selected from an unformatted pool of volumes in the same first removable media library (RML) from a different cartridge than the first volume X as indicated at a block 410.

Otherwise if the user specified affinity type is not equal to three, then as indicated at a decision block 412 checking is performed for a user specified affinity type equal to N, which indicates another user defined criteria. If the user specified affinity type equal to N is identified, then the second volume Y is selected from an unformatted pool of volumes in a defined removable media library (RML) based upon the defined criteria as indicated at a block 414.

The selected volume Y is formatted as indicated at a block 416. Then the sequential steps return as indicated at a block 418. Otherwise if the user specified affinity type is not equal to N, then an error is returned indicating an unknown affinity type as indicated at a block 420.

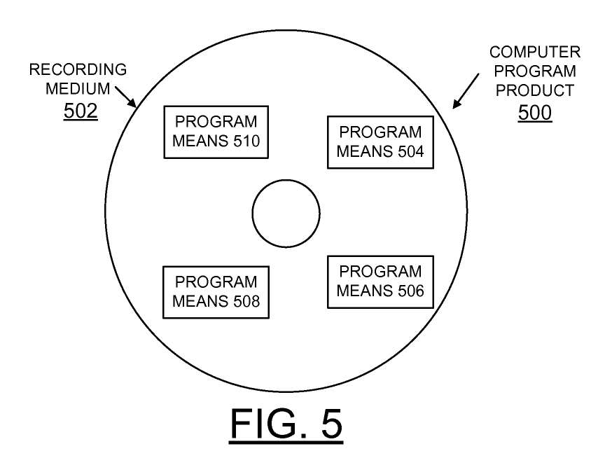

Referring now to FIG. 5, an article of manufacture or a computer program product 500 of the invention is illustrated. The computer program product 500 includes a recording medium 502, such as, a floppy disk, a high capacity read only memory in the form of an optically read compact disk or CD-ROM, a tape, or another similar computer program product. Recording medium 502 stores program means 504, 506, 508, 510 on the medium 502 for carrying out the methods for implementing enhanced data storage in a removable media library to optimize performance and reliability of the preferred embodiment in the system 100 of FIGS. 1 and 2.

A sequence of program instructions or a logical assembly of one or more interrelated modules defined by the recorded program means 504, 506, 508, 510, direct the computer system 100 for implementing enhanced data storage in a removable media library to optimize performance and reliability of the preferred embodiment.

While the present invention has been described with reference to the details of the embodiments of the invention shown in the drawing, these details are not intended to limit the scope of the invention as claimed in the appended claims.

What is claimed is:

1. A computer-implemented method for implementing enhanced data storage in a removable media comprising:
identifying an affinity between a first volume and a second volume for storing data using user specified affinity information for initially formatting two volumes;
defining a user specified affinity type value from the user specified affinity information;
selecting the first volume from a first removable media library (RML) and formatting the first volume; and
selecting the second volume based upon an identified user specified affinity type value and formatting the second volume.

2. The computer-implemented method as recited in claim 1 includes identifying a first affinity type for the user specified affinity type value, selecting the second volume to be formatted from a second removable media library (RML) different than the first RML of the first volume.

3. The computer-implemented method as recited in claim 2 includes selecting the second volume to be formatted from the second RML located at a different physical location than the first RML.

4. The computer-implemented method as recited in claim 1 includes identifying another affinity type for the user specified affinity type value, selecting the second volume to be formatted from a second removable media library (RML) different than the first RML of the first volume; and the second RML located at the same physical location as the first RML.

5. The computer-implemented method as recited in claim 1 includes identifying another affinity type for the user specified affinity type value, selecting the second volume to be formatted from a different cartridge in the first RML.

6. The computer-implemented method as recited in claim 1 includes selectively defining the identified user specified affinity type value in a number of ways by the user.

7. The computer-implemented method as recited in claim 1 includes using the user specified affinity information to intelligently select a plurality of unformatted cartridges in a group of removable media libraries (RMLs).

8. The computer-implemented method as recited in claim 1 includes using the user specified affinity information to intelligently select a plurality of unformatted cartridges in a single removable media library (RML).

9. An intelligent formatting computer program product for implementing enhanced data storage process with a removable media in a network computer system, said intelligent formatting computer program product tangibly embodied in a machine readable medium used in the data storage process with a removable media, said intelligent formatting computer program product including a removable media library (RML) selection control program, said intelligent formatting computer program product including instructions executed by the computer system to cause the computer system to perform the steps of:
identifying an affinity between a first volume and a second volume for storing data using user specified affinity information for initially formatting two volumes;
defining a user specified affinity type value from the user specified affinity information;
selecting the first volume from a first removable media library (RML) and formatting the first volume; and
selecting the second volume based upon an identified user specified affinity type value and formatting the second volume.

10. The intelligent formatting computer program product as recited in claim 9 includes identifying a first affinity type for the user specified affinity type value, selecting the second volume to be formatted from a second removable media library (RML) different than the first RML of the first volume.

11. The intelligent formatting computer program product as recited in claim 10 includes selecting the second volume to be formatted from the second RML located at a different physical location than the first RML.

12. The intelligent formatting computer program product as recited in claim 9 includes identifying another affinity type for the user specified affinity type value, selecting the second volume to be formatted from a second removable media library (RML) different than the first RML of the first volume; and the second RML located at the same physical location as the first RML.

13. The intelligent formatting computer program product as recited in claim 9 includes identifying another affinity type for the user specified affinity type value, selecting the second volume to be formatted from a different cartridge in the first RML.

14. The intelligent formatting computer program product as recited in claim 9 includes using the user specified affinity information to intelligently select a plurality of unformatted cartridges in a single removable media library (RML).

15. A system for implementing enhanced data storage process with a removable media comprising:
a processor,
intelligent formatting computer program product tangibly embodied in a machine readable medium used in the data storage process with a removable media, said intelligent formatting computer program product including a removable media library (RML) selection control program;
said processor using said intelligent formatting computer program product and said removable media library (RML) selection control program to perform the steps of:
identifying an affinity between a first volume and a second volume for storing data using user specified affinity information for initially formatting two volumes;
defining a user specified affinity type value from the user specified affinity information;
selecting the first volume from a first removable media library (RML) and formatting the first volume; and
selecting the second volume based upon an identified user specified affinity type value and formatting the second volume.

16. The system as recited in claim 15 includes said processor identifying a first affinity type for the user specified affinity type value, selecting the second volume to be formatted from a second removable media library (RML) different than the first RML of the first volume.

17. The system as recited in claim 16 includes said processor selecting the second volume to be formatted from the second RML located at a different physical location than the first RML.

18. The system as recited in claim 15 includes said processor identifying a another affinity type for the user specified affinity type value, selecting the second volume to be formatted from a second removable media library (RML) different than the first RML of the first volume; and the second RML located at the same physical location as the first RML.

19. The system as recited in claim 15 includes said processor identifying another affinity type for the user specified affinity type value, selecting the second volume to be formatted from a different cartridge in the first RML.

20. The system as recited in claim 15 includes said processor using the user specified affinity information to intelligently select a plurality of unformatted cartridges in a single removable media library (RML).
